(19) United States
(12) Patent Application Publication
(10) Pub. No.: US 2019/0230848 A1
(43) Pub. Date: Aug. 1, 2019

(54) SENSING AND AGITATION CONTROL SYSTEM FOR PARTICULATE MATERIAL

(71) Applicant: CNH INDUSTRIAL CANADA, LTD., Saskatoon (CA)

(72) Inventors: Jay Forrest, Saskatoon (CA); Benjamin McKnight, Aberdeen (CA); Jack Turner, Saskatoon (CA); Russell Louis Altman, Saskatoon (CA); Jared S. Wright, Saskatoon (CA)

(21) Appl. No.: 15/884,056

(22) Filed: Jan. 30, 2018

(51) Int. Cl. A01C 7/10; B01F 15/00; A01C 7/08; A01C 15/00

(52) U.S. Cl. CPC A01C 7/105; B01F 15/00285; B01F 15/00155; B01F 2215/0013; B01F 15/0035; A01C 15/005; B01F 2215/0009; A01C 7/084

(57) ABSTRACT

A particulate material sensing and agitation control system includes a controller with a memory and a processor, where the controller is configured to receive at least one sensor signal indicative of a measured profile of a particulate material within a storage tank of an agricultural system, determine whether a variation between the measured profile and a target profile is greater than a threshold value, and output a first output signal to a user interface indicative of instructions to inform an operator of a profile variation, output a second signal to an agitating system indicative of activation of the agitating system, or a combination thereof, in response to determining that the variation between the measured profile and the target profile is greater than the threshold value.

### BACKGROUND

The present disclosure relates generally to a sensing and agitation control system for particulate material.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Generally, agricultural seeding implements are towed behind a work vehicle, such as a tractor. These implements generally contain a particulate material, such as seeds, fertilizer, and/or other agricultural product, which is distributed on or in the ground using various methods. Certain implements include a storage tank in which the particulate material is stored and a metering system configured to meter the particulate material from the storage tank. The particulate material is distributed from the metering system to row units, which are configured to distribute the particulate material on or in the ground. As the storage tank is filled with the particulate material and/or while the particulate material flows from the storage tank to the metering system, the particulate material may create an undesirable profile within the storage tank. Several factors may contribute to this undesirable profile, including, but not limited to, friction between the particulate material and the storage tank, clumping of the particulate material, operation of the implement on a slope, and an inactive portion of the metering system. This undesirable profile may lead to uneven flow to the metering system, which may cause an unwanted distribution or no distribution of the particulate material over certain regions of a field. As a result, the crop yield within these regions may be reduced, thereby reducing the efficiency of the seeding process.

### BRIEF DESCRIPTION

Certain embodiments commensurate in scope with the disclosed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In one embodiment, a particulate material sensing and agitation control system includes a controller with a memory and a processor. The controller is configured to receive a sensor signal indicative of a measured profile of a particulate material within a storage tank of an agricultural system and determine whether a variation between the measured profile and a target profile is greater than a threshold value. The controller is also configured to output a first output signal to a user interface indicative of instructions to inform an operator of a profile variation, output a second output signal to an agitating system indicative of activation of the agitating system, or a combination thereof, in response to determining that the variation between the measured profile and the target profile is greater than the threshold value.

In another embodiment, a particulate material sensing and agitation control system includes an agitating system with a drive system, a sensor disposed above the agitating system, and a controller communicatively coupled to the sensor. The sensor is configured to detect a measured profile of a particulate material within a storage tank of an agricultural system. The controller is configured to receive a sensor signal from the sensor, determine whether a variation between the measured profile and a target profile is greater than a threshold value, and output an output signal to the drive system indicative of activation of the agitating system in response to determining that the variation between the measured profile and the target profile is greater than the threshold value.

In a further embodiment, a non-transitory computer readable medium includes executable instructions that, when executed by a processor, cause the processor to receive a sensor signal indicative of a measured profile of a particulate material within a storage tank of an agricultural system. The processor may determine whether a variation between the measured profile and a target profile is greater than a threshold value. The processor may also output a first output signal to a user interface indicative of instructions to inform an operator of a profile variation, output a second output signal to an agitating system indicative of activation of the agitating system, or a combination thereof, in response to determining that the variation between the measured profile and the target profile is greater than the threshold value.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural implement coupled to an air cart;

FIG. 2 is a perspective view of an embodiment of a metering system that may be employed within the air cart of FIG. 1;

FIG. 3 is a perspective view of an embodiment of a particulate material sensing and agitation control system positioned above the metering system of FIG. 2;

FIG. 4 is a top perspective view of the particulate material sensing and agitation control system of FIG. 3;

FIG. 5 is a side view of the particulate material sensing and agitation control system of FIG. 3 with particulate material disposed therein; and

FIG. 6 is a block diagram of an embodiment of an particulate material sensing and agitation control system that may be employed within the air cart of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Certain embodiments of the present disclosure include a particulate material sensing and agitation control system. Certain agricultural systems (e.g., air carts, implements, etc.) contain a particulate material (e.g., seeds, fertilizer, and/or other agricultural products) within a storage tank of the agricultural system. Certain agricultural systems are coupled to a respective implement and/or include an implement configured to distribute the particulate material within a field. The particulate material may flow from the storage tank through a metering system, which is configured to control the flow of the particulate material to the field. As the storage tank is filled with the particulate material or as the particulate material flows from the storage tank through the metering system, the profile of the particulate material within the storage tank may change.

Accordingly, in certain embodiments, a particulate material sensing and agitation control system includes at least one sensor, an agitating system having at least one drive system, and a controller. The sensor is configured to detect a measured profile of particulate material within a storage tank and to output a signal to the controller indicative of the measured profile. The controller is configured to compare the measured profile to a target profile. The target profile may be based on the implement type, the particulate material being distributed, the operation being performed, the target distribution of the particulate material within the field, etc. The target profile may also be input by an operator or determined by the controller. If the controller determines that a variation between the measured profile and the target profile is greater than a threshold value, the controller outputs a signal to a user interface indicative of instructions to inform an operator of a profile variation.

Additionally, or alternatively, the controller may output a signal to an agitating system indicative of activation of the agitating system. Activation of the agitating system causes a drive system to move an agitator. As an agitator within the agitating system moves, the particulate material may move from an area where the measured profile is above the target profile to an area where the measured profile is below than the target profile. As a result, the variation between the measured profile and the target profile may be reduced below the threshold values, thereby increasing the efficiency of seeding operations. The profile adjusting process may be performed both while particulate material is being distributed to the field and while the storage tank is being filled with the particulate material.

Furthermore, the particulate material sensing and agitation control system described herein may be installed in both new and existing agricultural systems. Installation of the sensing and agitation control system includes disposing an agitating system in a bottom portion of a storage tank of the agricultural system. The agitating system may be secured to the storage tank via various interface and mounting features, such as fasteners, tab extensions, etc. The agitating system may include a drive system having at least one motor configured to drive an agitator of the agitating system. Alternatively, existing motors within the agricultural system may drive the agitator.

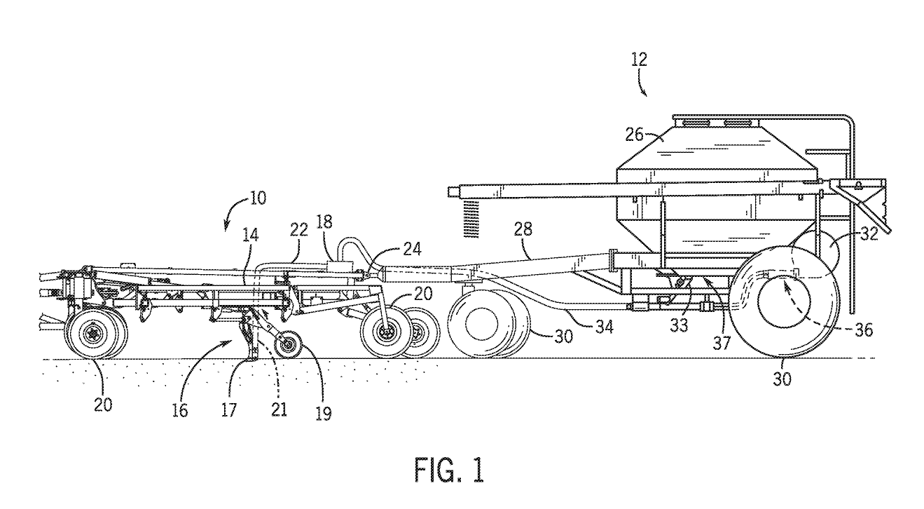

With the foregoing in mind, the present embodiments relating to particulate material sensing and agitation control systems may be utilized within any suitable agricultural system. For example, FIG. 1 is a side view of an embodiment of an agricultural implement 10 coupled to an air cart 12. A particulate material sensing and agitation control system may be used in the air cart 12. As depicted, the agricultural implement 10 includes a tool frame 14 coupled to a row unit 16 (e.g., ground engaging opener assembly), a header 18, and wheel assemblies 20. The agricultural implement may be pulled by a work vehicle (e.g., a tractor) to deposit rows of particulate material (e.g., agricultural product). Wheel assemblies 20 may contact the surface of the soil to enable the agricultural implement 10 to be pulled by the work vehicle. As the agricultural implement 10 is pulled, a row of the particulate material may be deposited into the soil by the row unit 16 (e.g., ground engaging opener assembly). Although only one row unit 16 is shown, the agricultural implement 10 may include multiple row units 16 organized in one or more rows across the agricultural implement 10. In some embodiments, the agricultural implement 10 may include one or more rows of 12, 14, 16, 18, 20, or more row units 16, which may each deposit a respective row of particulate material into the soil.

To facilitate depositing the particulate material, each row unit 16 (e.g., ground engaging opener assembly) in the illustrated embodiment, includes an opener 17, a press wheel 19, and a particulate material tube 21. While the opener 17 engages the soil, the opener 17 may exert a force onto the soil that excavates a trench into the soil as the row unit 16 travels through the field. The particulate material may be deposited into the excavated trench via the particulate material tube 21. Then, the press wheel 19 may pack soil onto the deposited particulate material. In certain embodiments, the press wheel of at least one row unit may be omitted. For example, at least one press wheel may be mounted to the frame of the implement behind the at least one row unit. Furthermore, while the illustrated row unit includes a ground engaging opener assembly, in alternative embodiments, at least one row unit on the implement may include an applicator assembly configured to deposit particulate material onto the surface of the field, or any other suitable type of product deposition assembly.

The header 18 may provide the particulate material to the row units 16. In some embodiments, the header 18 may pneumatically distribute the particulate material from a primary line to secondary lines. In the illustrated embodiment, a primary line 34 directs particulate material from the air cart 12 (e.g., a metering system 33 of the air cart) to the header 18. Additionally, the header 18 is configured to distribute the particulate material to the row units 16 via respective secondary lines 22. In certain embodiments, multiple primary lines may direct particulate material to multiple headers. Moreover, multiple secondary lines may extend from each header to respective row units. Furthermore, in certain embodiments, at least one secondary line may extend to a secondary header, and multiple tertiary lines may extend from the secondary header to respective row units.

In the illustrated embodiment, the air cart 12 is towed behind the agricultural implement 10. For example, the agricultural implement 10 may be coupled to the work vehicle by a first hitch assembly, and the air cart 12 may be coupled to the agricultural implement 10 by a second hitch assembly 24. However, in other embodiments, the agricultural implement may be towed behind the air cart. In further embodiments, the implement and the air cart may be part of a single unit that is towed behind the work vehicle or may be elements of a self-propelled vehicle.

The air cart 12 may centrally store particulate material and distribute the particulate material to the header 18. The air cart 12 includes a storage tank 26, a frame 28, wheels 30, and an air source 32. As illustrated, the towing hitch 24 is coupled between the tool frame 14 and the air cart frame 28, which enables the air cart 12 to be towed with the agricultural implement 10. Additionally, the storage tank 26 is configured to centrally store the particulate material. In some embodiments, the storage tank 26 may include multiple compartments for storing different types of particulate material. For example, a first compartment may store seeds while a second compartment may store a dry fertilizer. In such configurations, the air cart 12 may deliver both seeds and fertilizer to the implement 10 via separate distribution systems, or as a mixture through a single distribution system. Further, a particulate material sensing and agitation control system 37 may be disposed in the storage tank 26 and may be configured to control a profile of the particulate material in the storage tank 26.

From the particulate material sensing and agitation control system 37, the particulate material may be fed into a metering system 33, which meters the particulate material, fluidizes the particulate material via a fluidizing airflow from the air source 32, and distributes the particulate material to the header 18 via the primary line 34. As depicted, the metering system 33 is mounted to the bottom of the storage tank 26. To facilitate distributing the particulate material, the fluidizing air generated by the air source 32 is guided though the metering system 33 via a plenum 36. In some embodiments, the air source 32 may be one or more pumps and/or blowers powered by electric or hydraulic motor(s), for example.

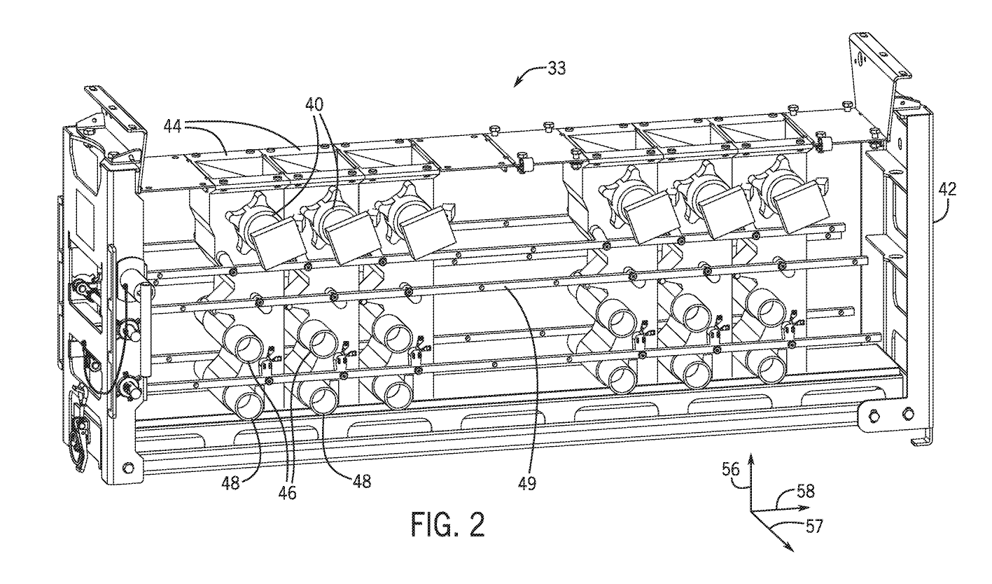

FIG. 2 is a perspective view of an embodiment of a metering system 33 that may be employed within the air cart of FIG. 1. As illustrated, the metering system 33 includes ten seed meters 40 supported by a frame 42. While the illustrated embodiment includes ten seed meters 40, more or fewer seed meters may be employed in alternative embodiments. For example, certain metering systems may include 1, 2, 4, 6, 8, 10, 12, 14, or more seed meters. In the illustrated embodiment, each seed meter 40 includes at least one respective metering device (e.g., meter roller) to control flow of particulate material to a respective conduit. Each seed meter 40 also includes an inlet 44 configured to receive the particulate material from the agitating system (e.g., along a vertical axis 56). Furthermore, each seed meter 40 includes a first conduit connector 46 and a second conduit connector 48. Each conduit connector is configured to receive the air flow from an air source and the particulate material from the metering device, thereby producing the air/material mixture. First conduits may be coupled to the first conduit connectors 46 and second conduits may be coupled to the second conduit connectors 48. Furthermore, the metering system 33 includes a gate 49 that enables selection of the first conduit connector 46 or second conduit connector 48. Once first conduit connector 46 or second conduit connector 48 is selected, particulate material flows through the selected conduit connector. The conduits may be coupled to respective row units and/or distribution headers that provide particulate material to multiple row units.

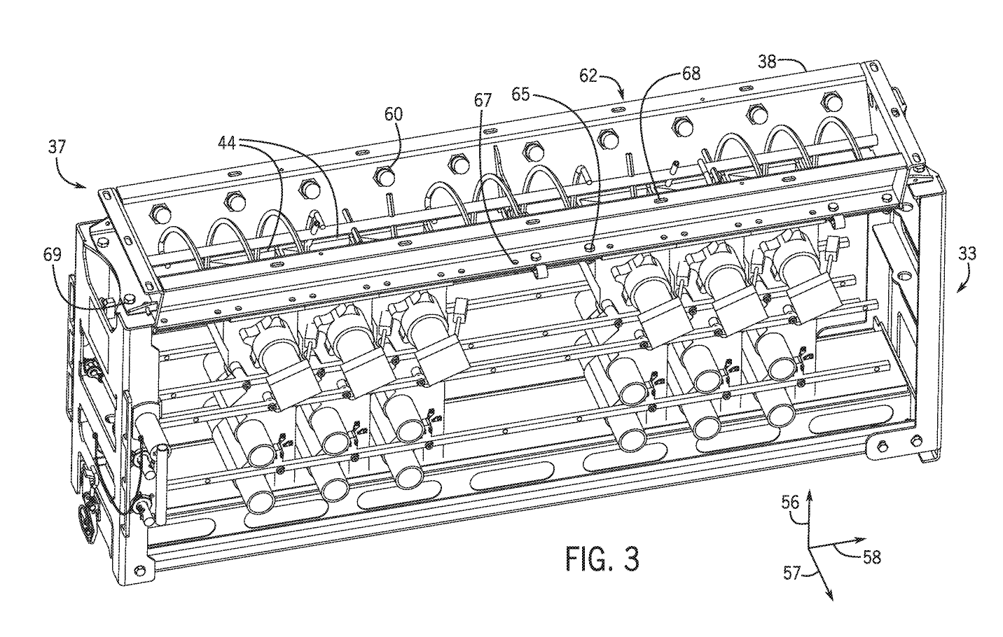

FIG. 3 is a perspective view of an embodiment of a particulate material sensing and particulate material sensing and agitation control system 37 positioned above the metering system 33 of FIG. 2. The particulate material may flow down the storage tank to the metering system 33 via the particulate material sensing and agitation control system 37. In the illustrated embodiment, the particulate material sensing and particulate material sensing and agitation control system 37 includes sensors 60 and an agitating system 62. As previously discussed, the particulate material sensing and agitation control system 37 may be disposed in the storage tank just above the metering system 33. As shown, the particulate material sensing and agitation control system 37 is disposed above the metering system 33 with respect to the vertical axis 56, such that the particulate material may flow from the particulate material sensing and agitation control system 37 into the inlets 44 of the metering system 33. In some embodiments, the particulate material may pass through other features of the agricultural system (e.g., air cart) before entering the metering system 33.

In the illustrated embodiments, the particulate material sensing and agitation control system 37 includes a hopper 38. The hopper 38 is secured to the metering system 33 by fasteners 65 disposed through holes 67 and 69 of the hopper. Holes 67 are arranged along a length of the hopper 38 (e.g., along the longitudinal axis 58), and holes 69 are arranged along a width of the hopper 38 (e.g., along the lateral axis 57). The hopper 38 also includes holes 68 configured to receive fasteners 65 for securing the hopper 38 to the storage tank housing structure or other portion of the agricultural system (e.g., air cart).

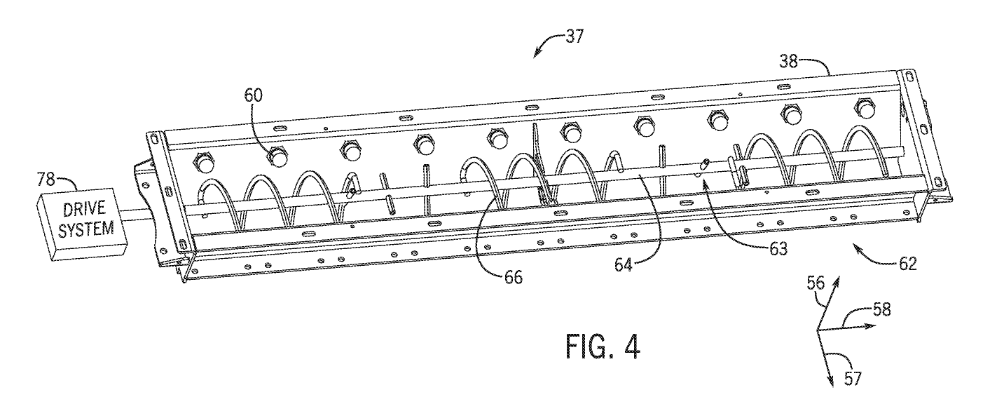

FIG. 4 is a top perspective view of the particulate material sensing and agitation control system 37 of FIG. 3. As illustrated, ten sensors 60 are placed along a wall of the hopper 38 (e.g., along the longitudinal axis 58). However, more or fewer sensors may be employed in alternative embodiments. For example, certain embodiments may include 1, 2, 3, 4, 6, 8, 10, 12, 14, or more sensors 60. The sensors 60 are configured to detect a measured profile of particulate material disposed in the particulate material sensing and agitation control system 37 and/or storage tank before, during, and/or after seeding operations. The measured profile is the shape of the top surface of particulate material disposed in the hopper and/or storage tank and may be one-dimensional or two-dimensional. Additionally, the measured profile consists of a series of levels in which each level spans the width of the hopper. For example, each sensor may detect a level of the top surface of particulate material in the hopper and/or storage tank. A measured profile may be determined based on the series of detected levels of particulate material.

A variety of sensor(s), such as ultrasonic sensor(s), electrostatic sensor(s), inductive sensor(s), Light Detection and Ranging (LIDAR) sensor(s), and/or other suitable sensor(s) may be used alone or in combination with one another to detect the measured profile of the particulate material. The sensor(s) may also be a camera disposed in the hopper and/or storage tank. The camera may be configured to detect the measured profile. Additionally, in alternative embodiments, the sensors 60 may disposed higher in the particulate material sensing and agitation control system 37 or may be disposed above the particulate material sensing and agitation control system 37 (e.g., along the vertical axis 56). As illustrated in FIG. 4, the sensors 60 are aligned in a row above the agitating system 62, however, the sensors 60 may be disposed in other suitable configurations/arrangements in the particulate material sensing and agitation control system 37 and/or in the storage tank.

An agitator 63 of the agitating system 62 is disposed within the hopper 38 along the longitudinal axis 58 and in an area below the sensors 60 relative to the vertical axis 56. As the particulate material rests in the storage tank, the particulate material may clump together to form pieces that are larger than desired (e.g., larger than the openings in the metering system). As such, when the particulate material flows through the agitating system 62, the clumps of particulate material break into smaller pieces more suitable for flowing through the metering system 33. The agitator 63 includes a shaft 64 coupled to a drive system 78 and a wrapped wire 66 coupled to the shaft 64. The wrapped wire 66 is wrapped around the shaft (e.g., in a cylindrical form, conical form, helical form, etc.) and enables the particulate material to flow between the shaft 64 and the wrapped wire 66. In the illustrated embodiment, the agitator 63 may rotate to move particulate material in the hopper 38 and/or storage tank. In certain embodiments, other types of agitators may be used in the agitating system. For example, an agitator may move linearly in the hopper to move the particulate material.

The drive system 78 of the particulate material sensing and agitation control system 37 may be configured to turn the agitator 63. The drive system 78 may be a motor configured to turn an agitator (e.g., an electric motor, hydraulic motor, etc.). In the illustrated embodiment, the drive system 78 includes a single motor disposed at end of the hopper 38, however, the drive system may include more than one motor (e.g., 2, 3, 4, 5, etc.). For example, the drive system may include a motor disposed at each end of the hopper. The drive system may also include motor(s) disposed along the length of the hopper. Motor(s) disposed along the length of the hopper may be connected to the agitator and may be configured to drive the agitator. As the agitator 63 turns, the particulate material moves within the hopper 38. Further, the agitator may be mounted higher in the storage tank relative to the hopper. For example, the agitator may be disposed above the hopper.

In the illustrated embodiment, the agitating system 62 includes a single agitator 63. In certain embodiments, multiple agitators (e.g., 2, 3, 4, 5, 6, 7, 8, etc.) may be disposed in the hopper 38 and/or storage tank. The agitators may be disposed in series or in parallel. In a configuration with more than one agitator, drive system(s) may drive only a portion of the agitators or all the agitators to move the particulate material in one or more directions. Multiple agitators may also be disposed at different levels in the hopper and/or storage tank. For example, one or more agitator(s) may be disposed in the hopper and one or more agitator(s) may be disposed higher in the storage tank.

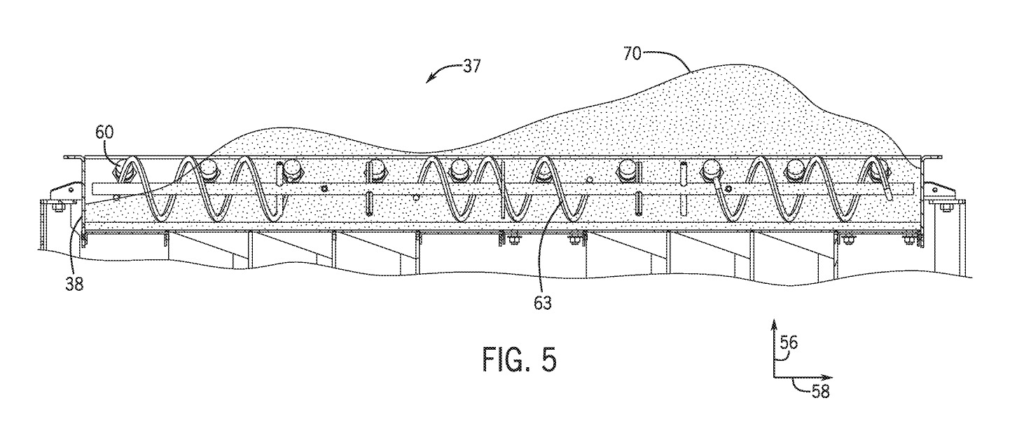

FIG. 5 is a side view of the particulate material sensing and agitation control system of FIG. 3 with particulate material disposed therein. The particulate material 70 is disposed at various levels within the hopper 38 along the longitudinal axis 58, thereby establishing a profile. The particulate material may be disposed above, below, partially above, and partially below the sensors 60. The sensors 60 may detect a measured profile of the particulate material 70 based on the position of the particulate material relative to the sensors 60. In the illustrated embodiment, the particulate material sensing and agitation control system 37 includes multiple sensors 60, each of which may be configured to detect a vertical level of the particulate material 70 proximate to the sensor (e.g., material height along the vertical axis 56). From the detected levels of particulate material 70, a measured profile may be established (e.g., by linearly extrapolating the data points or by another suitable method). Alternatively, a single sensor may be used alone or in combination with other sensors to detect a measured profile of the particulate material 70. For example, a single LIDAR sensor (e.g., mounted near a top portion of the storage tank) may be configured to detect the measured profile.

Furthermore, the sensors may also be used to detect levels of particulate material in the storage tank. An operator may desire to know the amount of particulate material remaining in the storage tank of an agricultural system, and the sensors may be configured to detect the particulate material within the storage tank. In this manner, information regarding the particulate material level in the storage tank and the profile proximate to the hopper may be collected and made available to the operator.

As illustrated in FIG. 5, the particulate material 70 is disposed in the hopper 38 below the far left sensor 60. In certain embodiments, the sensors 60 may detect that the measured profile of particulate material 70 is disposed below the far left sensor 60 and above the remaining sensors 60. The particulate material sensing and agitation control system 37 will compare the measure profile to a target profile. If a variation between the measured profile and the target profile is greater than a threshold value, the particulate material sensing and agitation control system 37 will cause an agitator 63 to activate and move particulate material toward the far left side of the hopper 38. Accordingly, the particulate material sensing and agitation control system 37 may decrease the variation between measured profile and the target profile. The target profile may be a one-dimensional or two dimensional profile and may consist of a series of levels in which each level spans the width of the hopper and/or storage tank. When the measured profile is compared to the target profile, individual corresponding levels of the measured profile and target profile are compared.

The target profile may also span all or a portion of the length of the hopper and/or storage tank. For example, if all of the seed rollers in a metering system are operating, the target profile may be consistent and/or flat across the entire hopper. In other embodiments, if only a portion of the seed rollers are active, the target profile may vary. For example, the target profile may be at a consistent first level over the active seed rollers and at a consistent second level over the non-active seed rollers. The target profile above the non-active seed rollers would essentially be zero. Accordingly, the particulate material sensing and agitation control system may move particulate material from an area of above non-active seed rollers to an area above active seed rollers.

The threshold value may be any value selected by an operator and/or determined by the particulate material sensing and agitation control system (i.e., 1 centimeter (cm), 2 cm, 3 cm, 4 cm, 5 cm, 10 cm, 50 cm, 100 cm, etc.). The threshold value may depend on the type of particulate material, the type of agricultural system, etc. being used. If a variation between a measured profile level and the corresponding target profile level exceeds the threshold value, the particulate material sensing and agitation control system responds by reducing the variation. The variation is the difference between the measured profile level and a corresponding target profile level.

The particulate material sensing and agitation control system may also only operate when the measured level of particulate material reaches a particular level in the storage tank. For example, the particulate material sensing and agitation control system may operate once the level of particulate material is at a level of one third of the storage tank capacity. An operator may choose to set this level to control operation of the particulate material sensing and agitation control system.

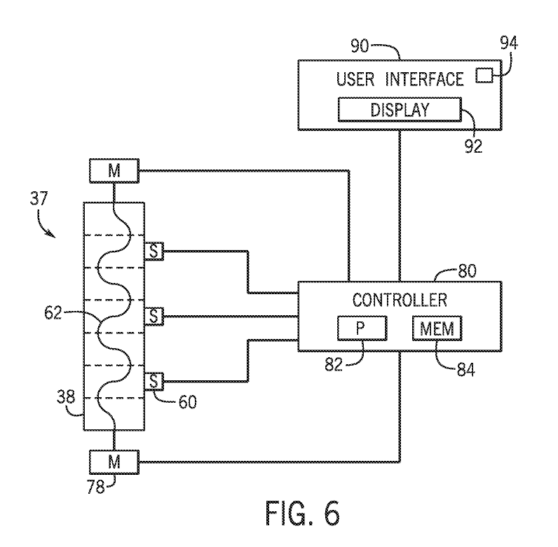

After the measured profile of particulate material is determined, the operator may be notified of a variation between the measured profile and a target profile of the particulate material, and the particulate material sensing and agitation control system may automatically take action to move the particulate material to decrease the difference between the measured profile and target profile. FIG. 6 is a block diagram of an embodiment of a particulate material sensing and agitation control system that may be employed within the air cart of FIG. 1. The sensors 60 may detect a measured profile of the particulate material in the hopper 38. Signals corresponding to the measured profile may be output from the sensors 60 to a controller 80. In certain embodiments, the controller 80 is an electronic controller and includes a processor 82 and a memory device 84. The controller 80 may also include one or more storage devices and/or other suitable components. Data included in the signals corresponding to the measured profile may be stored in the memory device 84 of the controller 80. Additionally, data corresponding to a target profile may be stored in the memory device 84. The target profile may be entered by the operator before or during operation of the agricultural system or may be determined based on data stored in the memory device 84.

The memory device 84 may include a volatile memory, such as random access memory (RAM), and/or a nonvolatile memory, such as read-only memory (ROM). The memory device 84 may store a variety of information and may be used for various purposes. For example, the memory device 84 may store processor-executable instructions (e.g., firmware or software) for the processor 82 to execute, such as instructions for controlling the drive system 78. The storage device(s) (e.g., nonvolatile storage) may include ROM, flash memory, a hard drive, or any other suitable optical, magnetic, or solid-state storage medium, or a combination thereof. The storage device(s) may store data (e.g., the target profile of particulate material, the number of rotations to turn an agitator, or the like), instructions (e.g., software or firmware for controlling the drive system 78), and any other suitable data. The processor 82 and/or memory device 84, and/or an additional processor and/or memory device, may be located in any suitable portion of the system. For example, a memory device for storing instructions (e.g., software or firmware for controlling portions of the drive system 78) may be located in or associated with the drive system 78.

In the illustrated embodiment, the controller 80 also includes a processor 82, such as a microprocessor. The processor 82 may be used to execute software, such as software for controlling the drive system 78. Moreover, the processor 82 may include multiple microprocessors, one or more “general-purpose” microprocessors, one or more special-purpose microprocessors, and/or one or more application specific integrated circuits (ASICS), or some combination thereof. For example, the processor 82 may include one or more reduced instruction set (RISC) or complex instruction set (CISC) processors.

If a variation between the measured profile of the particulate material and the target profile is greater than a threshold value, the controller 80 may send a signal to a user interface 90 indicative of instructions of inform an operator of a profile variation. In the illustrated embodiment, the user interface 90 includes a display 92, which may present information to an operator, including an indication that the variation between the measured profile and the target profile is greater than the threshold value. The display 92 may also be configured to present a graphical representation of the measured profile, the target profile, the threshold value, or a combination thereof. Based upon this display of information, the operator may activate the agitating system to decrease the variation between the measured profile and the target profile. For example, in the illustrated embodiment, the user interface 90 includes a user interaction device 94, such as button(s), that may send a signal to the drive system 78 indicative of activation of the agitating system 62. If the particulate material level is low at one portion of the hopper 38, the operator may select an operation of the agitating system 62 to control movement of the particulate material to that portion of the hopper 38.

Moreover, the agitating system 62 may move in either direction to move the particulate material. For example, if the particulate material is low in a portion of the hopper, such as at an end of the hopper, the operator may select a particular direction for the agitating system 62 to move. Accordingly, the agitating system 62 may move the particulate material to any portion of the hopper 38. Further, if more than one agitator is included in the agitating system, a drive system may be coupled to each agitator thereby enabling the direction of rotation of each agitator to be independently controllable.

Further, the agitator(s) in the agitating system may change direction and may move in the same and/or opposite directions. For example, if a single agitator is used in the particulate material sensing and agitation control system, the agitator may move in multiple directions to agitate and move the particulate material. The agitator may rotate in a first direction to move the particulate material and then in a second direction as required. In embodiments using multiple agitators, the agitators may move in the same direction to move particulate material to a particular portion of the hopper or may move in opposite directions to move the particulate material. For example, an agitator may be disposed at each end of a hopper. As particulate material flows through the hopper, the variation between the measured profile level of particulate material and target profile level may exceed a threshold value at each end of the hopper. In this example, the agitators disposed at each end may rotate in opposite directions to move the particulate material toward each end of the hopper.

The controller 80 may also output signals to the drive system 78 indicative of activation of the agitating system 62 in response to determining that the variation between the measured profile and the target profile is greater than the threshold value. Based on the signal from the controller 80, the drive system 78 may drive the agitator to decrease the variation between the measured profile and target profile of particulate material. In another embodiment, the drive system 78 may be connected to two or more agitators and may drive only a portion of the agitators or all of the agitators of the agitating system to decrease the variation between the measured profile and target profile of the particulate material. For example, if a variation between the measured profile and target profile exists in a portion of the hopper where only one agitator is disposed, the drive system may drive that agitator to move particulate material toward that portion of the hopper.

While only certain features have been illustrated and described herein, many modifications and changes will occur to those skilled in the art. It is, therefore, to be understood that the appended claims are intended to cover all such modifications and changes as fall within the true spirit of the disclosure.

1. A particulate material sensing and agitation control system, comprising:
a controller comprising a memory and a processor, wherein the controller is configured to:
receive at least one sensor signal indicative of a measured profile of a particulate material within a storage tank of an agricultural system;
determine whether a variation between the measured profile and a target profile is greater than a threshold value; and
output a first output signal to a user interface indicative of instructions to inform an operator of a profile variation, output a second output signal to an agitating system indicative of activation of the agitating system, or a combination thereof, in response to determining that the variation between the measured profile and the target profile is greater than the threshold value.

2. The particulate material sensing and agitation control system of claim 1, comprising at least one sensor communicatively coupled to the controller and configured to output at least one sensor signal.

3. The particulate material sensing and agitation control system of claim 2, wherein the at least one sensor comprises a plurality of sensors.

4. The particulate material sensing and agitation control system of claim 3, wherein a first sensor of the plurality of sensors is configured to be disposed at a middle portion of a storage tank, a second sensor of the plurality of sensors is configured to be disposed at a first end of the storage tank, and a third sensor of the plurality of sensors is configured to be disposed at a second end of the storage tank.

5. The particulate material sensing and agitation control system of claim 1, wherein the measured profile comprises a plurality of measured levels of the particulate material across the storage tank, and the target profile comprises a corresponding plurality of target levels of the particulate material across the storage tank.

6. The particulate material sending and agitation control system of claim 5, wherein the variation corresponds to one of the plurality of measured levels being lower than a corresponding one of the plurality of target levels.

7. The particulate material sensing and agitation control system of claim 2, wherein the at least one sensor is an ultrasonic sensor, an electrostatic sensor, a LIDAR sensor, a camera, or a combination thereof.

8. The particulate material sensing and agitation control system of claim 1, wherein the instructions to inform the operator of the profile variation comprise instructions to provide a recommendation to activate the agitation system.

9. The particulate material sensing and agitation control system of claim 1, wherein activation of the agitating system causes an agitator to move the particulate material.

10. A particulate material sensing and agitation control system, comprising:
an agitating system comprising at least one drive system;
at least one sensor disposed above the agitating system, wherein the at least one sensor is configured to detect a measured profile of a particulate material within a storage tank of an agricultural system; and
a controller communicatively coupled to the at least one sensor and configured to:
receive at least one sensor signal from the at least one sensor;
determine whether a variation between the measured profile and a target profile is greater than a threshold value; and
output an output signal to the at least one drive system indicative of activation of the agitating system in response to determining that the variation between the measured profile and the target profile is greater than the threshold value.

11. The particulate material sensing and agitation control system of claim 10, wherein the at least one sensor comprises a plurality of sensors.

12. The particulate material sensing and agitation control system of claim 11, wherein at least one sensor of the plurality of sensors is disposed above a respective meter roller.

13. The particulate material sensing and agitation control system of claim 10, wherein the at least one sensor is an ultrasonic sensor, an electrostatic sensor, a LIDAR sensor, a camera, or a combination thereof.

14. The particulate material sensing and agitation control system of claim 10, wherein the measured profile comprises a plurality of measured levels of the particulate material across the storage tank, and the target profile comprises a corresponding plurality of target levels of the particulate material across the storage tank.

15. The particulate material sensing and agitation control system of claim 10, wherein the variation corresponds to one of the plurality of measured levels being lower than a corresponding one of the plurality of target levels.

16. The particulate material sensing and agitation control system of claim 11, wherein a first sensor of the plurality of sensors is configured to be disposed at a middle portion of a storage tank, a second sensor of the plurality of sensors is configured to be disposed at a first end of the storage tank, and a third sensor of the plurality of sensors is configured to be disposed at a second end of the storage tank.

17. At least one non-transitory computer readable medium comprising executable instructions that, when executed by a processor, cause the processor to:
receive at least one sensor signal indicative of a measured profile of a particulate material within a storage tank of an agricultural system;
determine whether a variation between the measured profile and a target profile is greater than a threshold value; and
output a first output signal to a user interface indicative of instructions to inform an operator of a profile variation, output a second output signal to an agitating system indicative of activation of the agitating system, or a combination thereof, in response to determining that the variation between the measured profile and the target profile is greater than the threshold value.

18. The non-transitory computer readable medium of claim 17, wherein the instructions to inform the operator of the profile variation are configured to cause the processor to provide a recommendation to activate the agitating system.

19. The non-transitory computer readable medium of claim 17, wherein the measured profile comprises a plurality of measured levels of the particulate material across the storage tank, and the target profile comprises a corresponding plurality of target levels of the particulate material across the storage tank.

20. The non-transitory computer readable medium of claim 17, wherein the variation corresponds to one of the plurality of measured levels being lower than a corresponding one of the plurality of target levels.
